(19) United States
(12) Patent Application Publication
(10) Pub. No.: US 2016/0254075 A1
(43) Pub. Date: Sep. 1, 2016

(54) MEDICAL CABLE AND PRODUCTION METHOD THEREFOR

(71) Applicant: Hitachi Metals, Ltd., Tokyo (JP)

(72) Inventors: Detian HUANG, Hitachi (JP); Takanobu WATANABE, Hitachi (JP); Hiroo KUSANO, Hitachi (JP); Kimika KUDO, Kitaibaraki (JP)

(21) Appl. No.: 15/009,115

(22) Filed: Jan. 28, 2016

(30) Foreign Application Priority Data
Feb. 26, 2015 (JP) 2015-036640
Nov. 6, 2015 (JP) 2015-218026

(51) Int. Cl. H01B 7/02

(52) U.S. Cl. CPC H01B 7/0216

(57) ABSTRACT

A medical cable is composed of a cable core, a jacket formed around a circumference of the cable core, and a protective film formed around a circumference of the jacket. The jacket is formed of a silicone rubber. The protective film is a resin layer including a mixture of a fluorine resin and a silicone resin. A medical cable producing method includes applying a solution including a fluorine resin and a silicone resin dissolved or dispersed therein to a circumference of a jacket, and baking to form a protective film.

The present application is based on Japanese patent applications Nos. 2015-036640 and 2015-218026 filed on Feb. 26, 2015 and Nov. 6, 2015, the entire contents of which are incorporated herein by reference.

### BACKGROUND OF THE INVENTION

1. Field of the Invention

This invention relates to a medical cable, which is provided with a jacket made of a silicone rubber, and a producing method for that medical cable.

2. Description of the Related Art

In medical cables typified by probe cables, which connect a body of an ultrasonic diagnostic device and a probe together, or endoscope cables, which are used for surgical operation, etc., a jacket made of a silicone rubber is used.

The silicone rubber is a biocompatible material. Therefore, by using the jacket made of the silicone rubber, it is possible to achieve the medical cables suitably applicable to surgical applications, gynecological applications, etc.

Also, the silicone rubber is highly water and oil repellent and highly stainproof. Therefore, by using the jacket made of the silicone rubber, it is possible to even easily wipe and remove blood or other stains adhering to the jacket.

Furthermore, the silicone rubber is highly chemical resistant to alcohols and other disinfectants and highly heat resistant, and also undergoes little degradation even when subjected to sterilization such as plasma sterilization, autoclave sterilization, etc. Therefore, the silicone rubber is most suitable for medical applications where disinfection and sterilization are frequently performed.

Refer to JP-A-10-116520, for example.

### SUMMARY OF THE INVENTION

However, the silicone rubber has its sticky surface, and the medical cables using the jacket made of the silicone rubber therefore have the problem of poor handleability and poor storability, because they tend to be strongly stuck and entangled when routed for use or storage.

Accordingly, it is an object of the present invention to provide a medical cable, which is capable of mitigating the sticking of a jacket made of a silicone rubber, to enhance handleability and storability, and a producing method for that medical cable.

(1) According to one embodiment of the invention, a medical cable comprises:

a cable core;

a jacket formed around a circumference of the cable core, the jacket comprising a silicone rubber; and

a protective film formed around a circumference of the jacket, the protective film comprising a resin layer comprising a mixture of a fluorine resin and a silicone resin.

In the one embodiment, the following modifications and changes may be made.

(i) The protective film is not less than 10 μm and not more than 50 μm in thickness.

(ii) The protective film is formed by baking at a temperature lower than a rated temperature for the jacket.

(2) According to another embodiment of the invention, a medical cable producing method comprises

applying a solution comprising a fluorine resin and a silicone resin dissolved or dispersed therein to a circumference of a jacket, and baking to form a protective film.

### Points of the Invention

The present invention allows for providing the medical cable, which is capable of mitigating the sticking of the jacket made of the silicone rubber, to enhance handleability and storability, and the producing method for that medical cable.

### BRIEF DESCRIPTION OF THE DRAWINGS

The preferred embodiments according to the invention will be explained below referring to the drawings, wherein

FIG. 1 is a schematic sectional view showing a medical cable according to the present invention.

### DETAILED DESCRIPTION OF THE PREFERRED EMBODIMENTS

Below is described a preferred embodiment according to the invention, in conjunction with the accompanying drawing.

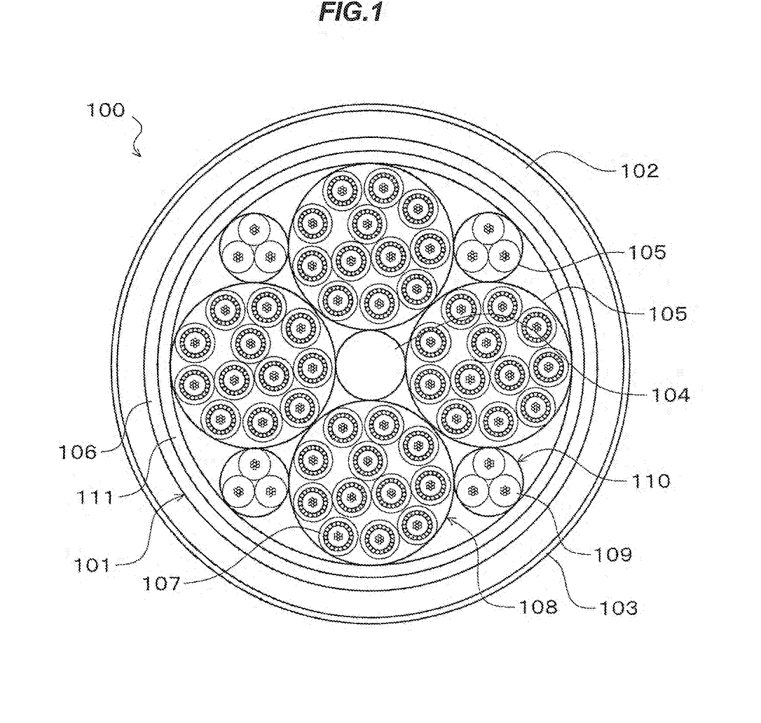

As shown in FIG. 1, a medical cable 100 in the preferred embodiment of the present invention is, for example, a probe cable to connect a body of an ultrasonic diagnostic device and a probe together, and is composed of a cable core 101, a jacket 102 formed around a circumference of the cable core 101, and a protective film 103 formed around a circumference of the jacket 102.

The cable core 101 is composed of a central inclusion (tension member) 104, a plurality of cable units 105 stranded together about the central inclusion 104, and a braided shield 106 formed around a circumference surrounding the plurality of cable units 105.

The central inclusion 104 is configured in such a manner that the plurality of cable units 105 are aligned concentrically thereabout at cable cross section and stranded together, to thereby be able to maintain the symmetry of the cable core 101, disperse external force, and enhance the bending resistance, twisting resistance, and flexibility of the cable core 101.

As the central inclusion 104 to enhance the resistance to tension, etc. applied in the cable longitudinal direction, there are, for example, high tensile strength fibers made of polyamide based fibers such as aramid, etc. or polyester based fibers such as polyethylene terephthalate, etc.

As the cable units 105, there are signal transmission units 108 each composed of a respective multiplicity of coaxial cables 107 assembled together, and power supply units 110 each composed of a respective multiplicity of electrically insulated cables 109 assembled together.

These cable units 105 are wrapped together with a binder tape 111 therearound, and their concentrically aligned and stranded shape at cable cross section is thereby maintained.

The jacket 102 is formed of a silicone rubber, and is biocompatible, water and oil repellent, stainproof, and chemical resistant, as mentioned previously.

The protective film 103 is a resin layer comprising a mixture of a fluorine resin and a silicone resin, and its thickness is at most on the order of not less than 10 μm and not more than 50 μm.

More specifically, a fluorine oil including the fluorine resin dissolved or dispersed therein and a silicone oil including the silicone resin dissolved or dispersed therein are mixed in, for example, a volatile organic solvent to be volatilized at a temperature lower than a rated temperature for the jacket 102, to prepare a mixture solution thereof. This mixture solution is applied to the circumference of the jacket 102, followed by baking at a temperature (e.g., not lower than 40 degrees C. and not higher than 80 degrees C.) lower than a rated temperature for the jacket 102 to volatilize the volatile organic solvent contained in the mixture solution, fix fluorine silicone coating comprising the mixture of the fluorine resin and the silicone resin to finely roughened portion inevitably present on the surface of the jacket 102, and form the very thin protective film 103. This results in the medical cable 100.

Note that when using a normal temperature volatile organic solvent which volatilizes at normal temperatures, it is possible to form the protective film 103 around the circumference of the jacket 102, by, after applying the mixture solution thereto, letting the mixture solution dry naturally to volatilize the volatile organic solvent contained in the mixture solution.

Now, in medical applications, because it is often necessary to wipe the surface of the medical cable 100 and remove blood or other stains adhering to the surface of the medical cable 100, the protective film 103 is designed to be delaminated more easily than in other applications.

In this regard, in the medical cable 100, the protective film 103 is formed by baking at a temperature lower than a rated temperature for the jacket 102 so that its fluorine silicone coating is more firmly fixed to the surface of the jacket 102 than when the protective film 103 is formed simply by natural drying. It is therefore possible to produce the protective film 103 less likely to be delaminated, and able to sufficiently withstand frequent wiping.

The fluorine component contributes to imparting lubricity and wear resistance. Therefore, using the protective film 103 containing the fluorine component allows for imparting lubricity and wear resistance to the medical cable 100, to mitigate the sticking of the jacket 102 made of the silicone rubber, to enhance the handleability and storability of the medical cable 100.

Incidentally, from the point of view of imparting lubricity and wear resistance to the medical cable 100, it is conceivable to extrusion coat a fluororesin around the circumference of the jacket 102 to form a protective layer therearound, but the fluororesin is high in hardness, and also difficult to extrusion coat for thin protective layer formation. The protective layer formation by the extrusion coating therefore causes the resulting medical cable 100 to lower in softness and flexibility.

Further, the fluororesin is low in adhesion. Therefore, the protective layer resulting from the extrusion coating of the fluororesin cannot be brought into close contact with the jacket 102, and is likely to cause gap formation at the interface between the jacket 102 and the protective layer, and appearance swelling which can cause damage to the protective layer, such as crack formation therein.

In contrast, in the medical cable 100, as described previously, the fixing of the fluorine silicone coating to the finely roughened portion inevitably present on the surface of the jacket 102 allows for the very thin protective film 103 formation therearound, therefore making it possible to impart the lubricity and the wear resistance to the medical cable 100 without lowering the softness and the flexibility of the medical cable 100.

Moreover, since it is possible to bring the protective film 103 into close contact with the jacket 102, even when blood or other stains adhering to the surface of the medical cable 100 are frequently wiped and removed, the protective film 103 is unlikely to be delaminated from the jacket 102, and allows for suppressing the gap formation at the interface between the jacket 102 and the protective film 103, or the appearance swelling which can cause damage to the protective film 103, such as crack formation therein.

Also, because the fluororesin has a high melting point, the protective layer formation by the extrusion coating of the fluororesin is likely to cause the jacket 102 to be exposed to high temperatures over 250 degrees C. and thermally degrade, lowering each of properties of the medical cable 100 secured by the jacket 102.

In contrast, in the medical cable 100, as described previously, the protective film 103 is formed around the surface of the jacket 102, by, after applying the mixture solution to the circumference of the jacket 102, baking at a temperature lower than a rated temperature for the jacket 102 to volatilize the solvent contained in the mixture solution. The jacket 102 is therefore prevented from being exposed to high temperatures over 250 degrees C. and thermally degrade, and it is therefore possible to prevent lowering each of properties of the medical cable 100 secured by the jacket 102.

In addition, since the protective film 103 is not less than 10 μm and not more than 50 μm, more preferably not less than 30 μm and not more than 40 μm in thickness, it is possible to impart the lubricity and the wear resistance to the medical cable 100 without substantially increasing the outer diameter of the medical cable 100. Also, the mixing ratio of the fluorine resin and the silicone resin in the protective film 13 ranges preferably from 8:2 to 5:5, and is especially preferably 7:3. The above mixing ratio may be achieved by adjusting a mixing ratio of the fluorine oil including the fluorine resin dissolved or dispersed therein and the silicone oil including the silicone resin dissolved or dispersed therein.

As described above, the present invention allows for providing the medical cable, which is capable of mitigating the sticking of the jacket made of the silicone rubber, to enhance handleability and storability, and the producing method for that medical cable.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A medical cable, comprising:
a cable core;
a jacket formed around a circumference of the cable core, the jacket comprising a silicone rubber; and
a protective film formed around a circumference of the jacket, the protective film comprising a resin layer comprising a mixture of a fluorine resin and a silicone resin.

2. The medical cable according to claim 1, wherein the protective film is not less than 10 μm and not more than 50 μm in thickness.

3. The medical cable according to claim 1, wherein the protective film is formed by baking at a temperature lower than a rated temperature for the jacket.

4. A medical cable producing method, comprising:
applying a solution comprising a fluorine resin and a silicone resin dissolved or dispersed therein to a circumference of a jacket, and baking to form a protective film.
